(19) United States
(12) Patent Application Publication
(10) Pub. No.: US 2007/0031324 A1
(43) Pub. Date: Feb. 8, 2007

(54) Niobium oxide and method for producing the same

(75) Inventors: Yoshihiro Yoneda, Ageo-shi (JP); Isamu Yashima, Ageo-shi (JP); Shuji Ogura, Ageo-shi (JP)

Correspondence Address: Richard S. Roberts;ROBERTS & ROBERTS, L.L.P., P.O. Box 484, Princeton, NJ, 08542-0484, US

(73) Assignee: MITSUI MINING & SMELTING CO., LTD.

(21) Appl. No.: 11/518,620

(22) Filed: Sep. 8, 2006

(30) Foreign Application Priority Data
Dec. 27, 2004 (JP) P2004-376287
Dec. 22, 2005 (JP) P2005-370259

(51) Int. Cl. C01G 31/02

(52) U.S. Cl. 423/594.17

(57) ABSTRACT

An object of the present invention is to provide a niobium oxide that is suitable for application to capacitors, high in purity, large in specific surface area and small in particle size. The present invention also provides a method for producing such a high-purity niobium oxide. The present invention provides a niobium oxide that is a low oxidation number niobium oxide obtained from a high oxidation number niobium oxide, characterized in that the niobium oxide has a specific surface area (BET value) of 2.0 m²/g to 50.0 m²/g. The production method comprising dry reducing niobium pentoxide to produce niobium monoxide is characterized in that the reduction treatment is carried out stepwise in two steps. In the stepwise reduction, it is preferable that a carbon-containing reducing agent be used at least in any one of the two steps, and the temperature and the ambient pressure be maintained in a predetermined range in each of the steps.

### TECHNICAL FIELD

The present invention relates to a niobium oxide large in specific surface area and small in particle size, and further relates to a method for producing the niobium oxide in a high purity.

### BACKGROUND ART

Recently, the amounts of niobium oxides used as raw materials for electronic components such as frequency filters and capacitors and as raw materials for targets in sputtering have been steeply growing. In particular, among the niobium oxides, niobium monoxide (NbO) has been adopted as a new type raw material for capacitors, and such capacitors have come into wide use in a prevailing manner as capacitors that actualize large capacities in forms of small-sized chips and are provided with excellent electric stabilities and high reliabilities.

In downsizing of niobium capacitors, it is essential to increase the electrostatic capacity of NbO to be dielectric material. The larger is the specific surface area of the niobium oxide as the raw material, the larger is the electrostatic capacity to be obtained. Increase of the purity of the niobium oxide can also increase the electrostatic capacity. Contamination of impurities such as alkali metals and heavy metals degrades the electric properties. Accordingly, the niobium oxide is required to be finer in particle size and large in specific surface area, and additionally high in purity.

Various production methods have been proposed for such niobium oxides. In Patent Document 1, there is utilized a method in which an ingot of niobium is hydrogenated and the thus obtained flaky powder of niobium is oxidized by doping or the like. However, this method in which a niobium oxide is obtained by oxidizing niobium encounters difficulties in controlling the reaction and in obtaining fine particles because of grain growth.

Consequently, the niobium oxide described in Patent Document 1 does not attain a specific surface area to sufficiently meet required electric properties in such a way that the BET specific surface area are 0.26 m²/g in Example 2, 0.46 m²/g in Example 3, 0.96 m²/g in Example 4 and the like.

In Patent Document 2, there is produced a low oxidation number niobium oxide by reducing a high oxidation number niobium oxide with a getter material such as tantalum, niobium, or magnesium and by heat treating. This method for producing a low oxidation number niobium oxide by metal reduction cannot efficiently produce a high-purity niobium oxide, and hence cannot be said as a satisfactory method. In Patent Document 2, although there is suggested a preferable range of the BET specific surface area, no specific realizability of such a range is presented in examples, and it is not made clear whether or not the method of Patent Document 2 can practically produce a niobium oxide falling within the preferable range concerned.

Patent Document 1: National Publication of International Patent Application No. 2002-507247

Patent Document 2: National Publication of International Patent Application No. 2002-524378

### DISCLOSURE OF THE INVENTION

Problems to be Solved by the Invention

As described above, a niobium oxide is attracting much attention as a next-generation capacitor material, and various production methods thereof have been offered. However, the niobium oxides obtained by the above described production methods are as large as approximately 1 to 2 μm in primary particle size and are not large enough in specific surface area to attain downsizing of capacitors.

In these circumstances, an object of the present invention is to provide a niobium oxide that are high in purity, large in specific area and small in particle size. Another object of the present invention is to provide a production method for highly efficiently obtaining a niobium oxide that is controlled in shape.

Means for Solving the Problems

For the purpose of solving the above described problems, the present inventors have made extensive studies to obtain a niobium oxide that is high in purity and is also controlled in shape. Consequently, the present inventors have developed a niobium oxide larger in specific surface area and finer in particle size than conventional niobium oxides.

Specifically, the present invention relates to a niobium oxide having a BET specific surface area of 2.0 m²/g to 50.0 m²/g. The specific surface area is preferably 3 m²/g or more, and more preferably 5 m²/g or more. When the specific surface area is less than 2.0 m²/g, a desired electrostatic capacity cannot be obtained when used for a capacitor. When the specific surface area exceeds 50.0 m²/g, the electrostatic capacity is increased, but there occurs a tendency to make easy ignition in air.

The niobium oxide of the present invention has an average particle size of desirably 2.0 μm or less in terms of the D₅₀ value. The mean particle size is preferably 1.0 μm or less, and more preferably 0.8 μm or less. This is because when the mean particle size exceeds 2.0 μm, the specific surface area becomes small and the desired electrostatic capacity cannot be obtained. Similarly to the specific surface area, it is also preferable that the mean particle size is not extremely fine and is 0.01 μm or more. When the mean particle size is less than 0.01 μm, there is a fear that niobium monoxide is not stable in air. Here, it is to be noted that the mean particle size D₅₀ value means the particle size value at which the cumulative volume as cumulated from the smaller particle size side is 50%.

Further, it is generally required that the low oxidation number niobium oxide (the definition thereof will be described later) to be used as a raw material for capacitors be high in purity. Accordingly, the niobium monoxide (NbO) contained in the low oxidation number niobium oxide preferably has a purity of 90% or more based on the X-ray analysis. This is because when the purity is less than 90%, the electric properties are degraded and hence desired performances as capacitors cannot be obtained.

As described above, the niobium oxide controlled in shape can be realized by carrying out a dry reduction treatment by using a carbon-containing reducing agent when the low oxidation number niobium oxide is produced from the high oxidation number niobium oxide. This is conceivably related to the fact that the dry reduction treatment with carbon in the present invention is based on the degassing reaction, namely, to the fact that the reduction reaction proceeds by elimination of carbon dioxide from the high oxidation number niobium oxide. By taking advantage of this degassing reaction, a niobium oxide high in purity and controlled in shape can be efficiently produced.

Here, the carbon-containing reducing agent is not limited to carbon, but is any one of carbon monoxide (CO), a metal carbide, and a hydrocarbon such as methane, ethane or propane or a mixture of two or more of these. In the reduction treatment of the present invention, the above described reducing agents may be used, but no particular constraint is imposed on the reaction that proceeds under the conditions that other reducing agents such as hydrogen and a metal are simultaneously involved. Here, the metal carbides most preferably include niobium carbides, and also include other carbides such as tantalum carbide and tungsten carbide that impart electric properties.

In the method according to the present invention for producing a niobium oxide comprising dry reducing a high oxidation number niobium oxide with a carbon-containing reducing agent to produce a low oxidation number niobium oxide, the low oxidation number niobium oxide is preferably produced by heating the high oxidation number niobium oxide and the carbon-containing reducing agent to a temperature range from 1000° C. to 1800° C., and by maintaining the ambient pressure at 100 Pa or less.

When a niobium oxide is subjected to a reduction treatment with a carbon-containing reducing agent, judging from the TPP diagram of the Nb—C—O system, niobium pentoxide (1000° C. to 1350° C.), niobium dioxide (1350° C. to 1600° C.) and niobium monoxide (1600° C. to 1800° C.) can be produced respectively in the temperature ranges indicated in the parentheses. Accordingly, the present inventors have made various examinations on the production experiments of the low oxidation number niobium oxide carried out under the conditions that the high oxidation number niobium oxides were maintained in the respective reduction treatment temperature ranges. Consequently, the present inventors have found that the reduction treatment into the low oxidation number niobium oxide can be carried out in a very high production efficiency by somewhat reducing the pressure of the reduction treatment ambient atmosphere when the temperature has reached the reduction treatment temperature concerned. The present inventors have also found that by carrying out the pressure reduction treatment so as for the pressure to be lower than 100 Pa at the reduction treatment temperatures of 1000° C. to 1800° C., the particle shape of the produced niobium oxides can be controlled.

The high oxidation number niobium oxide and the low oxidation number niobium oxide in the method for producing a niobium oxide according to the present invention mean the following oxides: in the order of from high oxidation number to low oxidation number, examples of the niobium oxides concerned include basically niobium pentoxide (Nb₂O₅), niobium dioxide (NbO₂) and niobium monoxide (NbO). The present invention intends to produce from a higher oxidation number oxide a lower oxidation number oxide of these niobium oxides. In addition to the above described niobium oxides, those niobium oxides that have intermediate oxidation numbers are known, and such intermediate oxidation number niobium oxides are not excluded in the present invention. Specifically, examples of such intermediate oxidation number niobium oxides include niobium oxides such as Nb_{16.8}O₄₂, Nb₁₂O₂₉, NbO_{1.64}, Nb₄O₅, NbO_{1.1}, NbO_{0.76} and NbO_{0.7}. Further, as a result of the reduction treatment in the present invention, metallic niobium (Nb) is produced as the case may be, and the method for producing a niobium oxide of the present invention does not exclude the production of metallic niobium (Nb).

When the reduction treatment temperature is lower than 1000° C., a dry reduction treatment with carbon cannot produce a low oxidation number niobium oxide from a high oxidation number niobium oxide. When the reduction treatment temperature exceeds 1800° C., there occur reduction reactions of the produced niobium oxide and eventually reduction to niobium (Nb) occurs. When the ambient pressure exceeds 100 Pa, the production efficiency tends to be degraded. The pressure reduction treatment can be made under the reduced pressure of approximately 70 Pa to 100 Pa to obtain niobium oxides sufficiently high in purity, although the pressure can be more reduced to approach a low vacuum.

The present inventors have also found that when the high oxidation number niobium oxide is niobium pentoxide (Nb₂O₅) and the low oxidation number niobium oxide is niobium monoxide (NbO), the purity of niobium monoxide is increased by carrying out a stepwise reduction treatment in which the dry reduction from niobium pentoxide to niobium dioxide (NbO₂) is the first step and the dry reduction from niobium dioxide to niobium monoxide is the second step.

Further, it is preferable that in the first step, heating to a temperature range from 1000° C. to 1600° C. is made and the ambient pressure is maintained at 100 Pa or less, and in the second step, heating to a temperature range from 1400° C. to 1800° C. is made and the ambient pressure is maintained at 100 Pa or less. At least in one of the two steps, a carbon-containing reducing agent is preferably used. By carrying out this sequence of the reduction treatments, an extremely high-purity niobium oxide is obtained.

It is also preferable to adopt a method of a sequence of reduction treatments in which niobium monoxide is produced under the conditions that the ambient pressure is maintained at 100 Pa or less, the first step heating is made within a temperature range from 800° C. to 1300° C. under a hydrogen atmosphere, and the second step heating is made by using a carbon-containing reducing agent within a temperature range from 1400° C. to 1800° C. The reduction carried out under a hydrogen atmosphere permits obtaining niobium dioxide small in mean particle size and large in specific surface area. This is due to the fact that the reduction proceeds even at low heating temperatures under a hydrogen atmosphere, and the grain growth of the niobium oxide can thereby be suppressed. More specifically, the first step reduction treatment in the hydrogen atmosphere produces niobium dioxide small in particle size, and consequently, the second step can finally yield niobium monoxide fine in particle size.

When niobium oxides are subjected to reduction treatments under a hydrogen atmosphere, judging from the TPP diagram of the Nb—H—O system, niobium pentoxide (800° C. to 1100° C.), niobium dioxide (1100° C. to 1300° C.) and niobium monoxide (1300° C. to 1500° C.) can be produced respectively in the temperature ranges indicated in the parentheses. Accordingly, when niobium dioxide is produced from niobium pentoxide, high-purity niobium dioxide can be efficiently obtained by maintaining the reduction treatment temperature within a range from 800° C. to 1300° C. In the present invention, when the reduction treatment temperature is lower than 800° C., niobium dioxide cannot be produced, and when the reduction treatment temperature exceeds 1300° C., the reduction reaction of the produced niobium dioxide occurs in such a way that niobium monoxide (NbO) is slowly produced.

As described above, by carrying out the two steps of reduction treatments, niobium monoxide can be produced in a very high purity, and the particle size and the specific surface area of the obtained niobium monoxide can be regulated. The two steps of reduction treatments may be carried out separately in a batchwise manner, or may be carried out continuously.

It is preferable to further carry out a step in which the low oxidation number niobium oxide obtained as the product of the above described reactions is heated at 1300° C. to 1500° C. under a hydrogen atmosphere. This is because a carbon-containing reducing agent is used in the production method of the present invention, and hence carbon compounds such as niobium carbides sometimes remain after the reactions. The high oxidation number niobium oxide also remains unreduced because of incomplete reduction thereof as the case may be. Accordingly, a niobium oxide extremely high in purity can be obtained by further applying a reduction treatment under a hydrogen atmosphere to the niobium oxide obtained by the above described production method of the present invention.

With reference to the above TPP diagram of the Nb—H—O system, when the low oxidation number niobium oxide is reduced under a hydrogen atmosphere to increase the purity thereof, the reaction is allowed to proceed efficiently by maintaining the temperature within a range from 1300° C. to 1500° C. When the temperature is lower than 1300° C., the purpose of removing the impurities to increase the purity cannot be attained. When the temperature exceeds 1500° C., the reduction reaction of the produced niobium monoxide proceeds to such an extent that niobium (Nb) is produced.

Although niobium oxides controlled in specific surface area and particle size are obtained by the above production method of the present invention, an additional milling step can make the particle size finer. The milling is preferably carried out with a milling device such as a rotary ball mill, a vibration ball mill, a planetary ball mill, a bead mill or an attritor. Examples of preferable milling media include: a medium containing iron as a main component such as a stainless steel; and α-alumina, zirconium oxide and silicon nitride.

When a milling step has been carried out, the niobium oxide having been subjected to milling sometimes contains traces of impurities derived from the milling medium. When such a contamination occurs, it is preferable to carry out after milling an impurity removing step such as a sedimentation classification step or an acid pickling step. In the acid pickling step, the niobium oxide obtained after milling is added with an acidic solution such as hydrochloric acid or sulfuric acid to prepare a slurry in such a way that an acid pickling over a predetermined period of time is carried out, and the impurities that have been contained in the milling step can thereby be removed.

### BRIEF DESCRIPTION OF THE DRAWINGS

FIG. 1 is a chart showing peak intensities in an X-ray analysis of the purity;

FIG. 2 is a chart showing enlarged peak intensities in the X-ray analysis of the purity;

FIG. 3 is a SEM observation photograph (magnification: 20000×) of a niobium pentoxide powder as a raw material;

FIG. 4 is a SEM observation photograph (magnification: 10000×) of the niobium dioxide obtained by a first-step reduction treatment at 1400° C. for 30 minutes in Example 1;

FIG. 5 is a SEM observation photograph (magnification: 10000×) of the niobium monoxide obtained by a second-step reduction treatment at 1600° C. for 30 minutes in Example 1;

FIG. 6 is a SEM observation photograph (magnification: 3000×) of the niobium monoxide obtained by a reduction treatment (300 minutes) in Example 13;

FIG. 7 is a SEM observation photograph (magnification: 10000×) of the niobium dioxide obtained by a reduction treatment at 900° C. in Example 7;

FIG. 8 is a SEM observation photograph (magnification: 10000×) of the niobium dioxide obtained by a reduction treatment at 1000° C. in Example 7;

FIG. 9 is a SEM observation photograph (magnification: 10000×) of the niobium dioxide obtained by a reduction treatment at 1100° C. in Example 7;

FIG. 10 is a SEM observation photograph (magnification: 10000×) of the niobium monoxide before milling in Example 15; and

FIG. 11 is a SEM observation photograph (magnification: 10000×) of the niobium monoxide after milling in Example 15.

### BEST MODE FOR CARRYING OUT THE INVENTION

Hereinafter, the best embodiments of the present invention will be described.

First Embodiment: in the first embodiment, description will be made on cases where a reduction treatment is carried out by using carbon as a reducing agent.

### Example 1

First Step: Description is made on a case where reduction was carried out by using carbon in the first step in which niobium pentoxide (Nb₂O₅) is subjected to dry reduction treatment into niobium dioxide (NbO₂). As the raw materials, niobium pentoxide and a commercially available carbon (the particle size observed with SEM: 0.1 to 100 μm) were used. In a carbon crucible, 4.78 kg of niobium pentoxide and 0.22 kg of carbon were placed and mixed under stirring. The mixed raw material (5.00 kg) was placed in a carbon vessel disposed in a vacuum heating furnace.

The temperature inside the vacuum heating furnace was increased at a rate of 20 to 25° C./min, and a pressure reduction was started at each of the temperatures of 1100° C., 1250° C. and 1400° C., and a reduction treatment was carried at 1400° C. for 30 minutes. The pressure reduction inside the furnace was carried out down to 10 Pa. Thereafter, each sample subjected to pressure reduction starting at the above described different temperatures was taken out and subjected to weighing of the produced NbO₂, and the purity thereof was derived on the basis of the X-ray analysis to be described later on in detail. The results thus obtained are shown in Table 1.

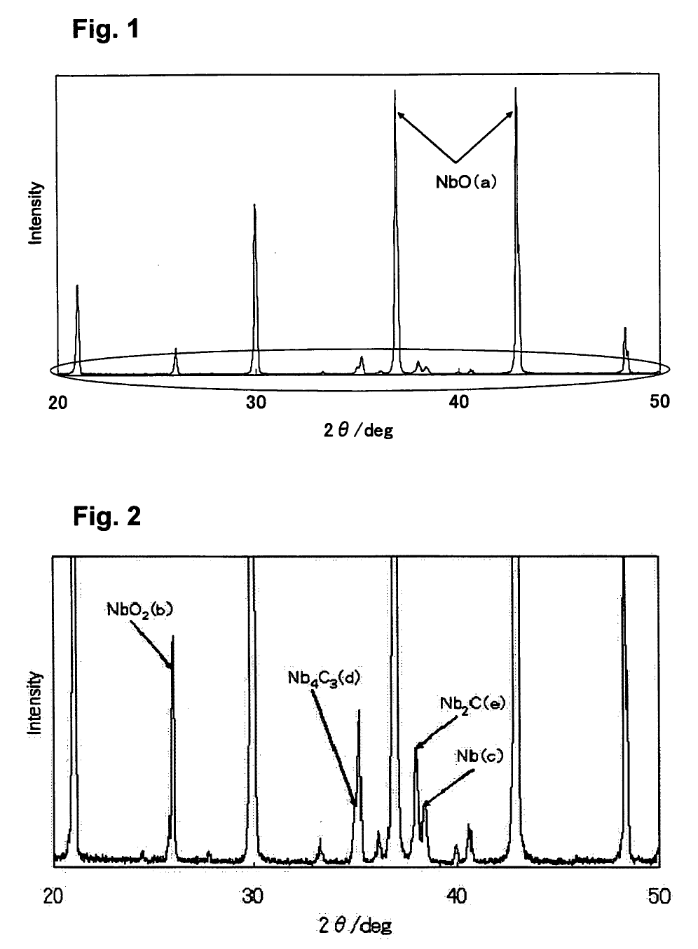

Purity measurement (X-ray analysis): The purities were analyzed with an X-ray diffractometer (XRD). In the charts obtained by X-ray analysis, shown in FIGS. 1 and 2, the portions indicated by the names of individual compounds refer to the respective primary peaks. FIG. 2 is an enlarged chart of the low intensity section (surrounded by an ellipse) in FIG. 1. The purities in the present invention were derived from the primary peak intensity ratios based on the chart. The locations of the primary peaks of the respective compounds in terms of angle 2θ are approximately as follows: NbO: the location of the higher peak (a) of the peaks at 37.0° and 43.0°; NBO₂: 26.0° (b); Nb: 38.4° (c); Nb₄C₃: 34.9° (d); and Nb₂C: 37.9° (e). Specifically, the purities were derived as the ratios of the peak intensities of the respective compounds to the sum of the peak intensities of all the compounds. For NbO, for example, the purity was determined by calculating the value of [a/(a+b+c+d+e)]×100 (%).

TABLE 1

| | |
|---|---|
| Pressure | |
| reduction | |
| starting | Balance (%) |

| temperature (° C.) | NbO₂ purity (%) | Nb₂O₅ | Nb₁₂O₂₉ |
|---|---|---|---|
| 1100 | 37 | 0 | 63 |
| 1250 | 70 | 0 | 30 |
| 1400 | 100 | 0 | 0 |

From the above results, there was found a tendency that the shift of the pressure reduction starting temperature to the higher temperature side increases the NbO₂ purity. It was revealed that when a reduction treatment was carried out by setting the pressure reduction starting temperature at 1400° C., the NbO₂ purity got up to 100%. The balance, exclusive of the produced NbO₂, was subjected to an X-ray analysis to carry out the identification and the quantitative determination of the constituent substances thereof. Consequently, it was verified that when the pressure reduction starting temperature was set at 1100° C., no unreduced Nb₂O₅ was identified in the balance, but the balance contained Nb₁₂O₂₉.

Second Step: Description is made on a case where reduction was carried out by using carbon in the second step in which niobium dioxide (NbO₂) is subjected to dry reduction treatment into niobium monoxide (NbO). As the raw material, the niobium dioxide obtained in the first step was used. In a carbon crucible, 4.56 kg of the niobium dioxide and 0.44 kg of the above described carbon were placed and mixed under stirring. The mixed raw material was placed in a carbon vessel disposed in a vacuum heating furnace. The pressure reduction was started at each of the pressure reduction starting temperatures of 1400° C., 1500° C. and 1600° C., and a reduction treatment was carried out at 1600° C. for 30 minutes. The pressure reduction inside the furnace was carried out down to 10 Pa.

Each of the samples subjected to pressure reduction starting at the above described different temperatures was taken out and subjected to weighing of the produced NbO, and the purity thereof was derived. The results thus obtained are shown in Table 2.

TABLE 2

| Pressure reduction | | | | | |
|---|---|---|---|---|---|
| starting temperature | NbO purity | Nb purity | Balance (%) | | |
| (° C.) | (%) | (%) | NbO₂ | Nb₂C | Nb₄C₃ |
| 1400 | 55 | 0 | 33 | 10 | 2 |
| 1500 | 76 | 1 | 23 | 0 | 0 |
| 1600 | 91 | 6 | 3 | 0 | 0 |

From the above results, there was clearly found a tendency that the shift of the pressure reduction starting temperature to the higher temperature side increases the NbO purity. It was revealed that when a reduction treatment was carried out by setting the pressure reduction starting temperature at 1500° C. or 1600° C., NbO₂ was partially subjected to reduction treatment into niobium (Nb). It was revealed that the reduction treatment at 1600° C. increased the NbO purity (inclusive of Nb) up to 97%. The balance was subjected to an X-ray analysis, and consequently, unreduced NbO₂ was identified, and it was revealed that when the pressure reduction starting temperature was set at 1400° C., Nb₂C and Nb₄C₃ as well as the unreduced NbO₂ were contained.

Reduction under Hydrogen Atmosphere: Description is made on reactions to reduce, under a hydrogen atmosphere, the niobium oxides produced by the reduction treatments in the first and second steps. The raw materials were 5 types of niobium monoxide samples that have different production steps, and were subjected to a reduction treatment under the same reaction conditions. In a tubular furnace having a hydrogen atmosphere, 0.1 kg of each niobium monoxide sample was placed. The temperature inside the furnace was set at 1400° C., and the reduction treatment was carried out for 2 to 4 hours. The NbO purity obtained by the reduction treatment was derived for each of the samples. The results thus obtained are shown in Table 3.

TABLE 3

| | Before reduction in hydrogen atmosphere | | | | | |
|---|---|---|---|---|---|---|
| | | | Balance | | | After reduction |
| | NbO purity | Nb purity | NbO₂ | Nb₂C | Nb₄C₃ | NbO purity |
| No. | (%) | (%) | (%) | (%) | (%) | (%) |
| 1 | 90 | 6 | 4 | 0 | 0 | 100 |
| 2 | 78 | 7 | 15 | 0 | 0 | 100 |
| 3 | 86 | 4 | 10 | 0 | 0 | 100 |
| 4 | 84 | 2 | 8 | 4 | 2 | 100 |
| 5 | 80 | 4 | 13 | 3 | 0 | 100 |

*The NbO purity after reduction includes the niobium oxides represented by the formula NbOₓ with the proviso that 0.7 ≦ x ≦ 1.1.

As can be seen from Table 3, further application of the reduction under a hydrogen atmosphere after each reduction treatment in the first and second steps provided such advantageous effects that unreacted niobium dioxide and remaining niobium carbides (Nb₂C, Nb₄C₃) were eliminated to permit efficiently producing high-purity niobium monoxide.

### Example 2

A Series of Reactions: Description is made on a series of reduction treatments for producing niobium monoxide by reducing niobium pentoxide. Carbon was used both in the first step and the second step, and the obtained product was reduced under a hydrogen atmosphere.

In the first step, 0.96 kg of niobium pentoxide and 0.04 kg of carbon were dry mixed and placed in a carbon crucible disposed in a vacuum heating furnace. The temperature inside the vacuum heating furnace was increased at a rate of 20° C./min, and the pressure reduction was started at 1400° C., and a reduction treatment was carried out at 1400° C. for 90 minutes. The pressure reduction inside the furnace was carried out down to 10 Pa. The sample subjected to the reduction treatment was taken out and subjected to X-ray analysis to carry out an identification and a quantitative determination of the constituent substances thereof. Consequently, 0.87 kg of niobium dioxide having a 100% purity was obtained.

Next, in the second step, 0.46 kg of the niobium dioxide thus obtained and 0.04 kg of carbon were used, the pressure reduction starting temperature and the reaction temperature were both set at 1500° C., and the reaction time was set at 10 minutes. The conditions other than those described above were the same as in the first step. The produced sample was found to have the following composition: niobium monoxide: 84%, metallic niobium (Nb): 2%, niobium dioxide: 8%, a niobium carbide (Nb₂C): 4%, and a niobium carbide (Nb₄C₃): 2%.

Finally, 0.1 kg of the sample obtained in the second step was subjected to a reduction treatment in a tubular furnace the interior of which was made to have a hydrogen atmosphere at the reaction temperature of 1400° C. for 4 hours. The obtained product was subjected to X-ray analysis to reveal that the product was NbO having a purity of 100%. The NbO as referred to herein includes the niobium oxides represented by the formula NbOₓ with the proviso that 0.7≦x≦1.1, and it should be understood that this is also the case in Examples presented below. The mean particle sizes D₅₀ and the specific surface areas of the samples obtained are shown in Table 7 presented below.

From the above results, it was revealed that high-purity niobium monoxide was able to be produced by applying a series of production methods in which reduction treatments were carried out by using carbon in the first and second steps, and further, reduction was carried out under a hydrogen atmosphere.

Second Embodiment: In the second embodiment, description will be made on a case where a reduction treatment is carried out by using a metal carbide (NbC) in the first and second steps, as a reducing agent in place of carbon.

### Example 3

Second Step: Description is made on a case where a niobium carbide was used as a reducing agent in the second step reaction in Example 1. The reduction was carried out under the same conditions as in Example 1 except that the reaction time was set at 90 minutes. It is to be noted that the temperature increase rate was set at 20° C./min and the reduction temperature was set at 1600° C. for each of the pressure reduction starting temperatures. The NbO purities thus obtained are shown in Table 4.

TABLE 4

| | | Balance | | | |
|---|---|---|---|---|---|
| Pressure reduction | NbO purity | Nb | NbO₂ | Nb₂C | Nb₄C₃ |
| starting temperature | (%) | (%) | (%) | (%) | (%) |
| 1400 | 53 | 0 | 31 | 8 | 8 |
| 1500 | 77 | 1 | 20 | 2 | 0 |
| 1600 | 92 | 2 | 5 | 1 | 0 |

As shown in Table 4, even when a niobium carbide was used as a reducing agent in the reduction reaction of the second step, niobium monoxide was obtained with purities approximately the same as those in the cases (Table 2) where carbon was used. In the balance, remaining niobium carbides (Nb₂C, Nb₄C₃) as well as unreacted NbO₂ were identified.

### Example 4

Second Step: The temperature inside the heating furnace was increased at a rate of 70° C./min and reduction was carried out in such a way that the temperature was not increased after the pressure reduction, and each of the pressure reduction starting temperature was maintained. The other conditions were the same as in Example 3. The NbO purities thus obtained are shown below.

TABLE 5

| | | Balance | | | |
|---|---|---|---|---|---|
| Pressure reduction | NbO purity | Nb | NbO₂ | Nb₂C | Nb₄C₃ |
| starting temperature | (%) | (%) | (%) | (%) | (%) |
| 1400 | 70 | 0 | 19 | 11 | 0 |
| 1500 | 80 | 4 | 13 | 3 | 0 |
| 1600 | 92 | 2 | 5 | 1 | 0 |

As can be seen from Table 5, at 1400° C. and 1500° C., the NbO purities were improved as compared to Example 3 (Table 4). This is considered ascribable to the difference such that in Example 4 the reduction temperatures were the same as the respective pressure reduction starting temperatures, namely, 1400° C. and 1500° C., but in Example 3, the pressure reduction temperature was 1600° C. It is conceivable that the temperature increase rate was fairly larger in Example 4 than in Example 3, so that the rate of the mutual reaction between the particles was improved. In the balance, remaining niobium carbides (Nb₂C, Nb₄C₃) as well as unreacted NbO₂ were identified.

### Example 5

A Series of Reactions: Description is made on a series of reactions in which reduction treatments were carried out by using carbon as a reducing agent in the first step and a niobium carbide as a reducing agent in the second step, and further a reduction treatment was carried out under a hydrogen atmosphere. Unless otherwise specified, the reaction conditions were the same as in Example 2. In the first step, under the pressure reduction condition of 100 Pa, 0.82 kg of niobium dioxide having a purity of 100% was obtained. In the second step, 0.35 kg of the niobium dioxide thus obtained and 0.15 kg of the niobium carbide were increased in temperature at a rate of 70° C./min, pressure reduction was started at 1600° C., and a reduction treatment was carried out at the same temperature for 90 minutes. The sample thus obtained was found to have the following composition: niobium monoxide: 92%, metallic niobium: 2%, niobium dioxide: 5%, and niobium carbide (Nb₂C): 1%. The sample was further reduced under a hydrogen atmosphere to yield NbO having a purity of 100% based on X-ray analysis. The results for the particle size and the specific surface area are shown in Table 7 presented below.

### Example 6

A Series of Reactions: Description is made on a series of reactions in which reduction treatments were carried out by using a niobium carbide both in the first step and in the second step. Unless otherwise specified, the reaction conditions were the same as in Example 5. In the first step, 0.88 kg of niobium pentoxide was reduced with 0.12 kg of a niobium carbide (NbC) to yield 0.92 kg of niobium dioxide having a purity of 100%. In the second step, there was obtained a product that was found to have the following composition: niobium monoxide: 90%, metallic niobium: 5%, niobium dioxide: 3%, and a niobium carbide (Nb₂C): 2%. The product was reduced under a hydrogen atmosphere to yield NbO having a purity of 100% based on X-ray analysis. The particle size and the specific surface area thereof are shown in Table 7.

From above described Examples 5 and 6, it has been revealed that high-purity niobium monoxide is able to be obtained even when a niobium carbide is used in place of carbon in either or both of the first and second steps.

Third Embodiment: In the third embodiment, description will be made on cases where in the first step, a reduction treatment was carried out under a hydrogen atmosphere instead of using carbon as a reducing agent.

### Example 7

First Step: In the first step, 1.0 kg of niobium pentoxide was placed in a tubular furnace, and in a hydrogen atmosphere, the pressure reduction was started at each of the temperatures of 900° C., 1000° C., 1100° C. and 1200° C., and a reduction treatment was carried out for 1 to 2 hours. Each sample subjected to pressure reduction starting at the above-described different temperatures was taken out and subjected to derivation of the NbO₂ purity. The results thus obtained are shown in Table 6.

TABLE 6

Balance (%)

| Reaction | | Nb₁₂O₂₉ | Nb₂O₅ |
|---|---|---|---|
| temperature (° C.) | NbO₂ purity (%) | (%) | (%) |
| 900 | 78 | 22 | 0 |
| 1000 | 99 | 1 | 0 |
| 1100 | 100 | 0 | 0 |
| 1200 | 100 | 0 | 0 |

From the above results, it has been revealed that high-purity niobium dioxide is obtained even when a reduction treatment is carried out in the first step under a hydrogen atmosphere instead of using carbon. The higher was the pressure reduction starting temperature, the higher was the NbO₂ purity, in such a way that the pressure reduction starting temperatures of 1100° C. or higher attained a purity of 100%. It has also been revealed that, as compared to the cases where carbon is used, no niobium carbides remains in the balance, and the reactions carried out at relatively low temperatures yield high-purity products. When the reduction treatment time was extended to 4 to 12 hours at 900° C. or 1000° C., the NbO₂ purity was able to attain 100%.

### Example 8

A Series of Reactions: Description is made on a series of reactions in which in the first step reduction was carried out under a hydrogen atmosphere, and in the second step reduction was carried out with carbon and further under a hydrogen atmosphere. Unless otherwise specified, the reaction conditions were the same as in Example 2. In a tubular furnace, 1.0 kg of niobium pentoxide was placed, and then a reduction treatment was carried out at 1000° C. under a hydrogen atmosphere for 4 hours to yield 0.90 kg of niobium dioxide having a purity of 100%. The niobium dioxide thus obtained was reduced with carbon at 1600° C. for 90 minutes to yield a product having the following composition: niobium monoxide: 90%, metallic niobium: 6% and niobium dioxide: 4%. The product was further reduced in a hydrogen atmosphere at 1300° C. to yield niobium monoxide having a purity of 100%. The particle size and the specific surface area thereof are shown in Table 7.

### Example 9

A Series of Reactions: A series of reactions was carried out under the same conditions as in Example 8 except that the reaction temperature in the second step was decreased to 1400° C. In the first step, there was obtained 0.91 kg of niobium dioxide having a purity of 100%. In the second step, there was obtained a product having the following composition: niobium monoxide: 85%, metallic niobium: 4% and niobium dioxide: 11%. The product was further reduced in a hydrogen atmosphere to yield niobium monoxide having a purity of 100%. The particle size and the specific surface area thereof are shown in Table 7.

### Example 10

A Series of Reactions: Description is made on a series of reactions in which in the first step a reduction treatment was carried out under a hydrogen atmosphere, and in the second step reduction was carried out with a niobium carbide and further under a hydrogen atmosphere. Unless otherwise specified, the reaction conditions were the same as in Example 8. In the first step in which the reduction temperature was set at 1100° C., 0.89 kg of niobium dioxide having a purity of 100% was obtained. Thereafter, the second step was carried out in such a way that a niobium carbide was used as a reducing agent, the pressure reduction was started at 1500° C., and the reduction reaction was carried out at the same temperature. The sample thus obtained was found to have the following composition: niobium monoxide: 80%, metallic niobium: 4%, niobium dioxide: 13% and a niobium carbide: 3%. The sample was further subjected to a reduction treatment under a hydrogen atmosphere to yield niobium monoxide having a purity of 100%. The particle size and the specific surface area thereof are shown in Table 7.

According to above Examples 8 to 10, even when a reduction treatment was carried out under a hydrogen atmosphere in the first step, high-purity niobium monoxide was able to be obtained. The niobium dioxide obtained in the first step was observed to be finer in particle size than the niobium dioxide obtained by reduction with carbon.

### Example 11

A Series of Reactions: Description is made on a case where the time of each of the reduction treatments was elongated in a series of reactions in which, in the same manner as in Example 8, in the first step reduction was carried out under a hydrogen atmosphere, and in the second step reduction was carried out with carbon and further under a hydrogen atmosphere. Unless otherwise specified, the reaction conditions were the same as in Example 8. In the first step, a reduction treatment was carried out within a temperature range from 800° C. to 900° C. for 6 days to yield 0.91 kg of niobium dioxide having a purity of 100%. Further, in the second step, a reduction treatment was carried out at 1300° C. for 12 days. The sample thus obtained was found to have the following composition: niobium monoxide: 83%, niobium dioxide: 11% and a niobium carbide: 6%. The sample was further reduced under a hydrogen atmosphere at 1200° C. for 6 days to yield niobium monoxide having a purity of 100%. The particle size and the specific surface area thereof are shown in Table 7.

From the above results, it has been verified that even when the reduction treatments are elongated in time, high-purity niobium monoxide is able to be obtained.

### Example 12

A Series of Reactions: Here, description will be made on a case where the reduction treatments were carried out within the temperature ranges different from those in above described Examples 1 to 11. Unless otherwise specified, the reaction conditions were the same as in Example 8. In the first step, a reduction was carried out under the temperature condition of 1250° C. for 1 hour to yield 0.88 kg of niobium dioxide. The second step was carried out at a reduction temperature of 1850° C. to yield a product having the following composition: niobium monoxide: 88%, metallic niobium: 10% and a niobium carbide: 2%. Further, the product was subjected to a reduction treatment under a hydrogen atmosphere at 1500° C. for 3 hours to yield niobium monoxide having a purity of 100%. The particle size and the specific surface area thereof are shown in Table 7 presented below.

From the above results, it has been verified that even when the reduction temperatures is set as in Example 12, niobium monoxide is obtained so as to have a purity of 100%.

Particle Size Measurement: The mean particle size D₅₀ of the niobium oxide produced according to each of Examples and Comparative Examples was measured as follows. First, a small amount of the niobium oxide was put in 100 ml of purified water and was dispersed by stirring or by mixing with a paint shaker (manufactured by Red Devil Equipment Co.). Then, a fraction of the dispersion liquid thus obtained was taken out and subjected to a particle size distribution measurement with a particle size distribution analyzer (trade name: LA-920; manufactured by Horiba Ltd.; refractive index: 1.60) to derive the D₅₀ value.

Specific Surface Area Measurement (the BET method): The specific surface area based on the BET method was measured for the niobium oxide produced according to each of Examples and Comparative Examples with a BET specific surface area analyzer (Micromeritics Flow Sorb II-2300 manufactured by Shimadzu Corp.) by using a nitrogen-helium mixed gas containing approximately 30% by volume of nitrogen as an adsorbing gas and approximately 70% by volume of helium as a carrier gas, and the results thus obtained are shown in Table 7. (JIS R 1626 “Method for measuring the specific surface area of a fine ceramic powder by means of the gas adsorption BET method,” 6.2 Fluxion Method, (3.5) One point method)

In the following, the measured results of the particle size and the specific surface area of each of Examples are shown.

TABLE 7

| | | | D₅₀ | Specific |
|---|---|---|---|---|
| | First | Second | value | surface area |
| Example | step | step | (μm) | (m²/g) |
| Example 2 | C | C | 0.76 | 7.9 |
| Example 5 | C | NbC | 0.84 | 7.1 |
| Example 6 | NbC | NbC | 1.28 | 5.6 |
| Example 8 | H | C | 0.42 | 14.3 |
| Example 9 | H | C | 0.31 | 20.3 |
| Example 10 | H | NbC | 0.48 | 10.7 |
| Example 11 | H | C | 0.17 | 38.6 |
| Example 12 | H | C | 1.76 | 1.8 |

* The D₅₀ values were measured with LA-920.

According to the above results, there was obtained niobium monoxide having a specific surface area as large as 5.0 m²/g in the cases (Examples 5 and 6) where reduction was carried out with a carbon-containing reducing agent such as a niobium carbide as well as the case (Example 2) where reduction was carried out with carbon. It was also verified that in each of the cases (Examples 8 to 11) where in the first step, reduction was carried out under a hydrogen atmosphere, the specific surface area was 10 m²/g or more to be further larger. In Example 12, there was obtained niobium monoxide in which the specific surface area was somewhat smaller than 2.0 m²/g, but the D₅₀ value was small.

### Example 13

Pressure Reduction Treatment: Next, description will be made on a case where, in the reduction treatment with carbon in the first step, the pressure reduction starting time was set at the same time as the start of heating. In a carbon crucible, 4.40 kg of niobium pentoxide and 0.60 kg of carbon were placed; the mixture thus obtained was started to be increased in temperature at a rate of 20° C./min, at the same time the pressure inside the furnace was reduced down to 1 Pa, and the mixture was eventually heated to 1700° C. Thereafter, at 1700° C., two different ways of reduction treatment, namely, 30-minute and 300-minute reduction treatments, were carried out. Each of the products thus obtained was taken out and the NbO purity thereof was derived. The results thus obtained are shown in Table 8.

TABLE 8

| Reduction | NbO | | |
|---|---|---|---|
| treatment | purity | Nb | |
| time (min) | (%) | purity (%) | Balance (%) |
| 30 | 91 | 4 | Unreduced |
| | | | Nb₂O₅ |
| 300 | 96 | 4 | — |

From the above results, it has been verified that the reduction treatment at 1700° C. for 30 minutes permits obtaining a NbO purity (inclusive of Nb) of 95%. Alternatively, the reduction treatment at 1700° C. for 300 minutes attained a NbO purity (inclusive of Nb) of 100%.

For comparison, the reduction treatments both in the first step and in the second step each were carried out under a hydrogen atmosphere. In the second step, the reaction was carried out at a reduction temperature set at 1300° C. to 1600° C. for a reduction time set at 1 hour to 24 hours; the reaction conditions were otherwise the same as in Example 8. After the reduction treatments, the obtained product was subjected to X-ray analysis to derive the purities, and it was thereby revealed that niobium monoxide (NbO) was produced in a proportion of approximately 3 to 15% and the reduction was mostly limited to the production of niobium dioxide (NbO₂).

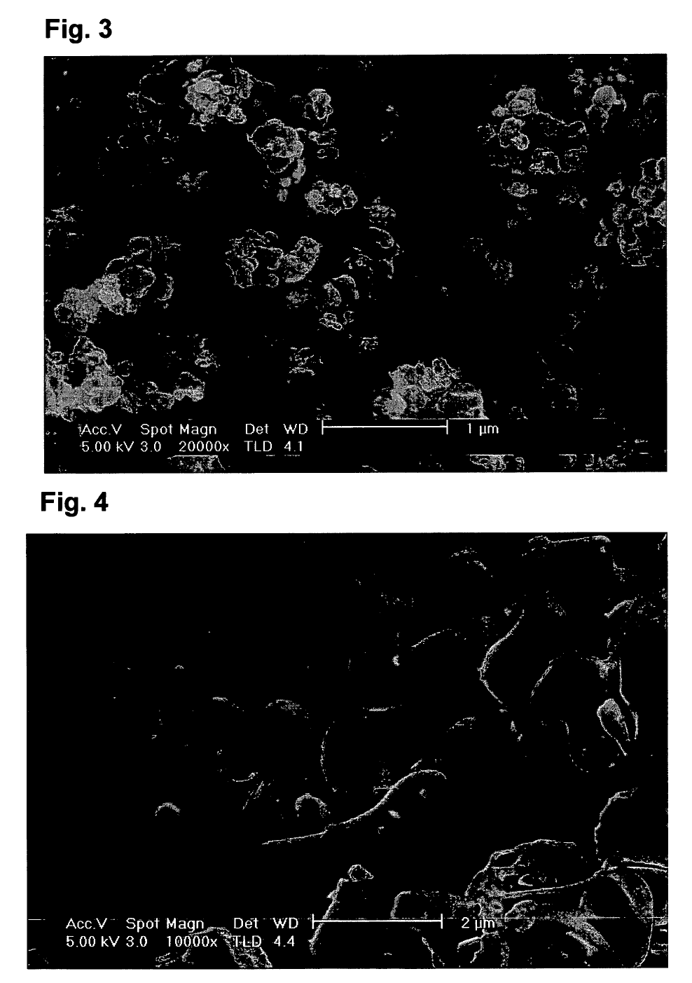

Observation of Niobium Oxide Powder: The shapes of the niobium oxide powders obtained in above described Examples and Comparative Examples were observed with a scanning electron microscope (SEM). The SEM observation photographs are shown in FIGS. 3 to 9.

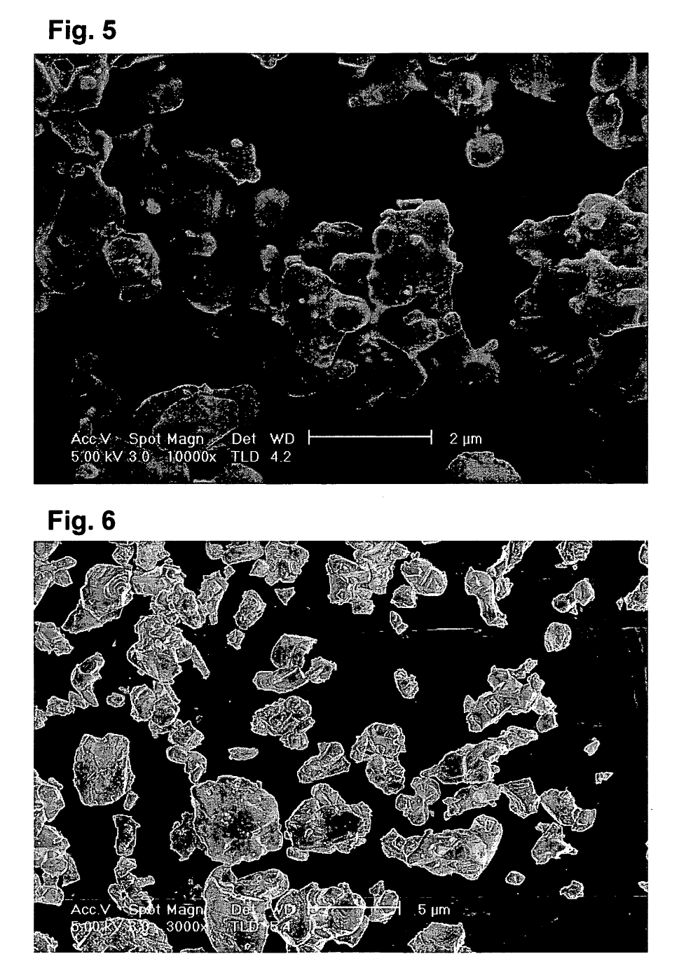

FIG. 3 is an observation of niobium pentoxide as a raw material; FIG. 4 is an observation of the niobium dioxide obtained by the first-step reduction treatment at 1400° C. for 30 minutes in Example 1; FIG. 5 is an observation of the niobium monoxide obtained by the second-step reduction treatment at 1600° C. for 30 minutes in Example 1; and FIG. 6 is an observation of the niobium monoxide obtained by the reduction treatment for 300 minutes in Example 13.

For the raw material powder shown in FIG. 3, the primary particle size was identified to be 50 to 400 nm. In contrast to this, as can be seen from FIG. 6, the niobium monoxide powder of Example 13 obtained by carrying out the 300-minute reduction treatment was identified to undergo the grain growth of the primary particles (growing to have a particle size of 2 to 3 μm), and facets were recognized. On the other hand, the niobium dioxide powder in FIG. 4 was identified to undergo the grain growth of the primary particles (growing to have a particle size of 1 to 2 μm). The niobium monoxide powder in FIG. 5 little exhibited the grain growth of the primary particles, and was identified to have approximately the same particle size as that of the primary particles of the niobium dioxide obtained in Example 1.

According to the above results, when the pressure reduction is started after reaching each of the reduction treatment temperatures, as in Example 1, niobium oxide can be efficiently produced, and the purity is improved with increasing reduction temperature. It has been revealed that in the production of niobium monoxide from niobium pentoxide, elongation of the reduction treatment time results in promotion of grain growth (Example 13), but application of the two steps of reduction treatment (Example 1) permits producing niobium monoxide in a high purity with suppressed grain growth.

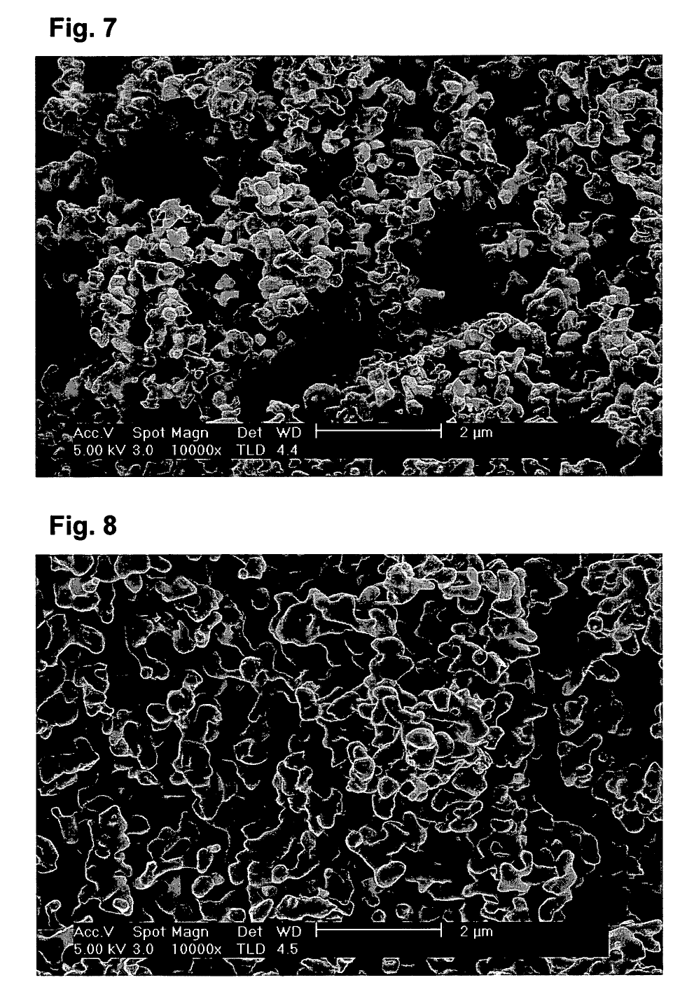

Next, FIGS. 7 to 9 are the observations of the niobium dioxide products obtained in Example 7 through the reduction treatments under a hydrogen atmosphere by setting the heating temperature at 900° C., 1000° C. and 1100° C. in FIGS. 7, 8 and 9, respectively.

In FIG. 7, the primary particles were identified to be finest to have particle sizes of 0.1 to 0.2 μm. In contrast to this, in each of FIGS. 8 and 9, the grain growth was promoted gradually, and the primary particles in FIG. 9 were observed to have particle sizes of 0.5 to 1.0 μm. From these results, it has been revealed that the reduction treatment under a hydrogen atmosphere yields more efficiently fine niobium dioxide as the heating temperature is lower.

Fourth Embodiment: In the fourth embodiment, description will be made on cases where a milling step is added for the purpose of making finer the particles of the niobium oxides obtained by the above described production steps.

### Example 14

Zirconia Ball: A bead mill (Ready Mill, manufactured by Imex Co., Ltd.) was used as a milling device, and a zirconia ball (a milling medium made of zirconium oxide) of 0.2 mm in diameter was used as a milling medium. First, 0.1 liter of the zirconia balls for milling were placed in the milling vessel (volume: 0.4 liter) of the bead mill, and secondly, there was placed a slurry composed of 63 g of niobium monoxide (the product of the present invention) as a target of milling and 92 g of purified water so as to have a concentration of 40% by weight. Under this condition, the bead mill was operated at a rotation speed of 2600 rpm to carry out wet milling for 2.5 hours. The milled sample was taken out and subjected to measurements of the mean particle size and the BET specific surface area. Consequently, the niobium monoxide having been milled was found to have an average particle size of 0.48 μm in terms of D₅₀ and a specific surface area of 10.7 m²/g, and to contain 6800 ppm of zirconium oxide (ZrO₂).

According to the above results, addition of a milling step was also able to attain a desired mean particle size and a desired BET specific surface area.

### Example 15

Carbon Steel Ball: Description is made on a milling step in which a carbon steel ball of 1.0 mm in diameter was used as a milling medium. The milling conditions were the same as in Example 14 except that the rotation speed was set at 2500 rpm and the milling time was set at 3.0 hours. The sample thus obtained was found to have an average particle size of 0.75 μm in terms of D₅₀ and a specific surface area of 11.7 m²/g, and to contain 49600 ppm of iron (Fe).

Next, an acid pickling step was carried out to remove the remaining Fe. The niobium monoxide obtained by the above described milling step was converted into a slurry having a concentration of 30% by weight by using H₂SO₄ having an acid concentration of 12 N, and an acid pickling was carried out for 30 minutes. Consequently, it was verified that the concentration of the Fe remaining in the obtained sample was reduced to 200 ppm.

As described above, a milling step using a carbon steel ball also permitted obtaining niobium monoxide having approximately the same mean particle size and specific surface area as those obtained when zirconia was used. Further, there was found a positive effect such that by carrying out acid pickling, the remaining Fe generated by the milling medium was reduced from 49600 ppm to 200 ppm. There has been revealed a method that permits obtaining a niobium oxide controlled in shape and high in purity by applying the step concerned.

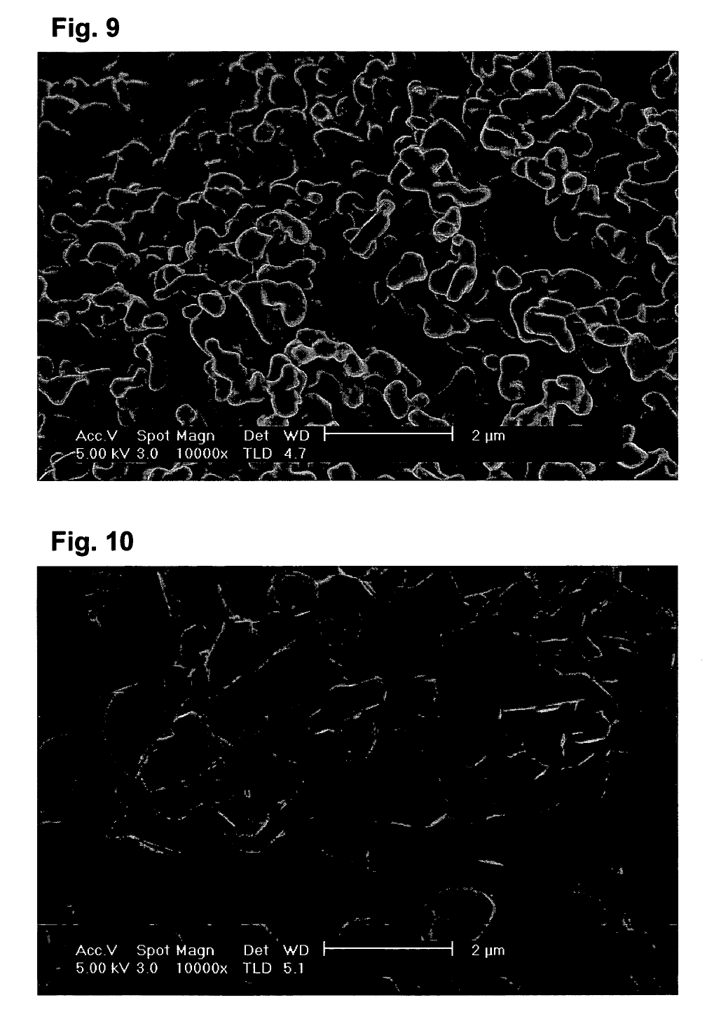

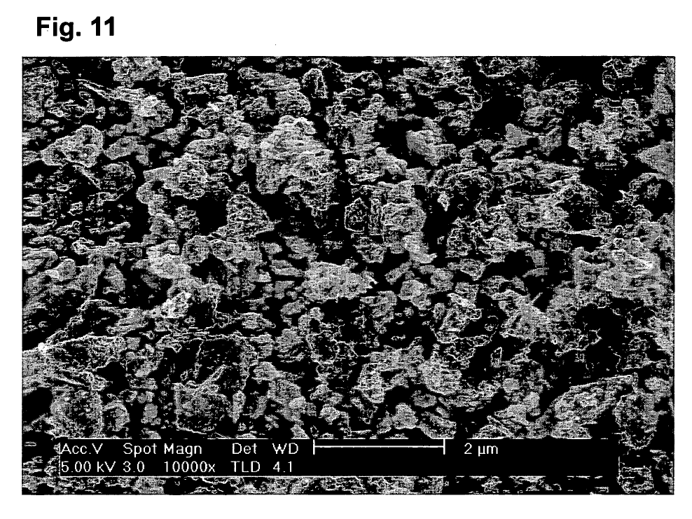

The SEM photographs in FIGS. 10 and 11 show observations of the niobium monoxide respectively before and after the milling step in Example 15. In FIG. 10, the sizes of the primary particles were found to be 1.5 to 2.0 μm. In contrast to this, in FIG. 11, fine particles having particle sizes of 0.2 to 0.4 μm were identified. Consequently, it has been revealed that the addition of the milling step significantly promotes the operation to make particles finer.

### INDUSTRIAL APPLICABILITY

As described above, the niobium oxide according to the present invention is a powder that is high in purity, and additionally, large in specific surface area and fine in particle size. The niobium oxide having a shape thus controlled has an effective applicability as a raw material for electronic components and the like. For example, as an application to capacitors, the niobium oxide having ensured such a high specific surface area as in the present invention can be used as raw materials that permit obtaining high electrostatic capacities, and accordingly, can be effectively used to downsize capacitors. Application of the production method according to the present invention permits efficiently obtaining niobium oxide that is high in purity and controlled in shape.

1. A niobium oxide which is a lower oxidation number niobium oxide obtained from a higher oxidation number niobium oxide, wherein the niobium oxide has a specific surface area (BET value) of 2.0 m²/g to 50.0 m²/g.

2. The niobium oxide according to claim 1, wherein the lower oxidation number niobium oxide has an average particle size of 2.0 μm or less in terms of mean particle size D₅₀ value.

3. The niobium oxide according to claim 1, wherein the lower oxidation number niobium oxide contains niobium monoxide (Nba), and the niobium monoxide contained has a purity of 90% or more based on an X-ray analysis.

4. A method for producing a niobium oxide, comprising dry reducing a higher oxidation number niobium oxide to a lower oxidation number niobium oxide with a carbon-containing reducing agent.

5. The method for producing a niobium oxide according to claim 4, wherein at the time of reduction, a heating temperature range is set from 1000° C. to 1800° C. and ambient pressure is maintained at 100 Pa or less.

6. A method for producing a niobium oxide comprising dry reducing niobium pentoxide (Nb₂O₅) as a higher oxidation number niobium oxide to produce niobium monoxide (NbO) as a lower oxidation number niobium oxide, wherein the dry reducing is carried out as a stepwise reduction comprising a first step to produce niobium dioxide (NbO₂) from niobium pentoxide and a second step to produce niobium monoxide from niobium dioxide; and a carbon-containing reducing agent is used in at least one of the two steps.

7. The method for producing a niobium oxide according to claim 6, wherein: the first step produces niobium dioxide by heating niobium pentoxide and a carbon-containing reducing agent to a temperature range from 1000° C. to 1600° C. and by maintaining the ambient pressure at 100 Pa or less; and the second step produces niobium monoxide by heating the niobium dioxide and a carbon-containing reducing agent to a temperature range from 1400° C. to 1800° C. and by maintaining the ambient pressure at 100 Pa or less.

8. The method for producing a niobium oxide according to claim 6, wherein: the first step produces niobium dioxide by heating niobium pentoxide under a hydrogen atmosphere to a temperature range from 800° C. to 1300° C.; and the second step produces niobium monoxide by heating the niobium dioxide and a carbon-containing reducing agent to a temperature range from 1400° C. to 1800° C. and by maintaining the ambient pressure at 100 Pa or less.

9. The method for producing a niobium oxide according to claim 4 wherein the carbon-containing reducing agent is any of carbon, carbon monoxide (CO), a metal carbide and a hydrocarbon, or a mixture of two or more of these.

10. A method for producing a niobium oxide, comprising heating a niobium oxide obtained by the method for producing a niobium oxide according to claim 4 under a hydrogen atmosphere to a temperature range from 1300° C. to 1500° C. to produce a high-purity lower oxidation number niobium oxide.

11. The niobium oxide according to claim 2, wherein the lower oxidation number niobium oxide contains niobium monoxide (Nba), and the niobium monoxide contained has a purity of 90% or more based on an X-ray analysis.

12. The method for producing a niobium oxide according to claim 5 wherein the carbon-containing reducing agent is any of carbon, carbon monoxide (CO), a metal carbide and a hydrocarbon, or a mixture of two or more of these.

13. The method for producing a niobium oxide according to claim 6 wherein the carbon-containing reducing agent is any of carbon, carbon monoxide (CO), a metal carbide and a hydrocarbon, or a mixture of two or more of these.

14. The method for producing a niobium oxide according to claim 7 wherein the carbon-containing reducing agent is any of carbon, carbon monoxide (CO), a metal carbide and a hydrocarbon, or a mixture of two or more of these.

15. The method for producing a niobium oxide according to claim 8 wherein the carbon-containing reducing agent is any of carbon, carbon monoxide (CO), a metal carbide and a hydrocarbon, or a mixture of two or more of these.

16. A method for producing a niobium oxide, comprising heating a niobium oxide obtained by the method for producing a niobium oxide according to claim 5 under a hydrogen atmosphere to a temperature range from 1300° C. to 1500° C. to produce a high-purity lower oxidation number niobium oxide.

17. A method for producing a niobium oxide, comprising heating a niobium oxide obtained by the method for producing a niobium oxide according to claim 6 under a hydrogen atmosphere to a temperature range from 1300° C. to 1500° C. to produce a high-purity lower oxidation number niobium oxide.

18. A method for producing a niobium oxide, comprising heating a niobium oxide obtained by the method for producing a niobium oxide according to claim 7 under a hydrogen atmosphere to a temperature range from 1300° C. to 1500° C. to produce a high-purity lower oxidation number niobium oxide.

19. A method for producing a niobium oxide, comprising heating a niobium oxide obtained by the method for producing a niobium oxide according to claim 8 under a hydrogen atmosphere to a temperature range from 1300° C. to 1500° C. to produce a high-purity lower oxidation number niobium oxide.

20. A method for producing a niobium oxide, comprising heating a niobium oxide obtained by the method for producing a niobium oxide according to claim 9 under a hydrogen atmosphere to a temperature range from 1300° C. to 1500° C. to produce a high-purity lower oxidation number niobium oxide.
